(19) United States
(12) Patent Application Publication
(10) Pub. No.: US 2026/0136238 A1
(43) Pub. Date: May 14, 2026

(54) TECHNOLOGIES FOR BUFFER STATUS REPORTING

(71) Applicant: Apple Inc., Cupertino, CA (US)

(72) Inventors: Ping-Heng Kuo, London (GB); Fangli Xu, Beijing (CN); Ralf Rossbach, Munich (DE); Haijing Hu, Los Gatos, CA (US)

(73) Assignee: Apple Inc., Cupertino, CA (US)

(21) Appl. No.: 19/119,088

(22) PCT Filed: Nov. 3, 2022
(86) PCT No.: PCT/CN2022/129640

§ 371 Date: Apr. 7, 2025

Related U.S. Application Data
(60) Provisional application No. 63/414,843, filed on Oct. 10, 2022.

(51) Int. Cl. H04W 28/02; H04L 69/322

(52) U.S. Cl. CPC H04W 28/0278; H04L 69/322

(57) ABSTRACT

The present application relates to devices and components including apparatus, systems, and methods for buffer status reporting in wireless networks.

### RELATED APPLICATION

This application claims priority to U.S. Provisional Application No. 63/414,843 filed Oct. 10, 2022, the entire disclosure of which is hereby incorporated by reference.

### TECHNICAL FIELD

This application relates generally to communication networks and, in particular, to technologies for buffer status reporting in such networks.

### BACKGROUND

Buffer status reports are important mechanisms for a user equipment (UE) to inform a base station on an amount of uplink data that has arrived in a buffer of the UE. The base station may use this information to allocate uplink resources to accommodate the buffered data. Details about using buffer status reports in Third Generation Partnership Project (3GPP) networks is provided in 3GPP Technical Specification v17.2.0 (2022-10-01).

### BRIEF DESCRIPTION OF THE DRAWINGS

FIG. 1 illustrates a network environment in accordance with some embodiments.

FIG. 2 illustrates a configurable mapping in accordance with some embodiments.

FIG. 3 illustrates a signaling diagram in accordance with some embodiments.

FIG. 4 illustrates a configurable mapping in accordance with some embodiments.

FIG. 5 illustrates a signaling diagram in accordance with some embodiments.

FIG. 6 illustrates an operational flow/algorithmic structure in accordance with some embodiments.

FIG. 7 illustrates a buffer status report media access control control element in accordance with some embodiments.

FIG. 8 illustrates a configurable mapping in accordance with some embodiments.

FIG. 9 illustrates a signaling diagram in accordance with some embodiments.

FIG. 10 illustrates an operational flow/algorithmic structure in accordance with some embodiments.

FIG. 11 illustrates another operational flow/algorithmic structure in accordance with some embodiments.

FIG. 12 illustrates another operational flow/algorithmic structure in accordance with some embodiments.

FIG. 13 illustrates another operational flow/algorithmic structure in accordance with some embodiments.

FIG. 14 illustrates a user equipment in accordance with some embodiments.

FIG. 15 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer an application processor; baseband processor, a central processing unit (CPU); a graphics processing unit; a single-core processor; a dual-core processor; a triple-core processor; a quad-core processor, or any other device capable of executing or otherwise operating computer-executable instructions, such as program code; software modules; or functional processes.

The term “interface circuitry” as used herein refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to computer, storage, or network resources provided by physical hardware element(s). A “virtualized resource” may refer to computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

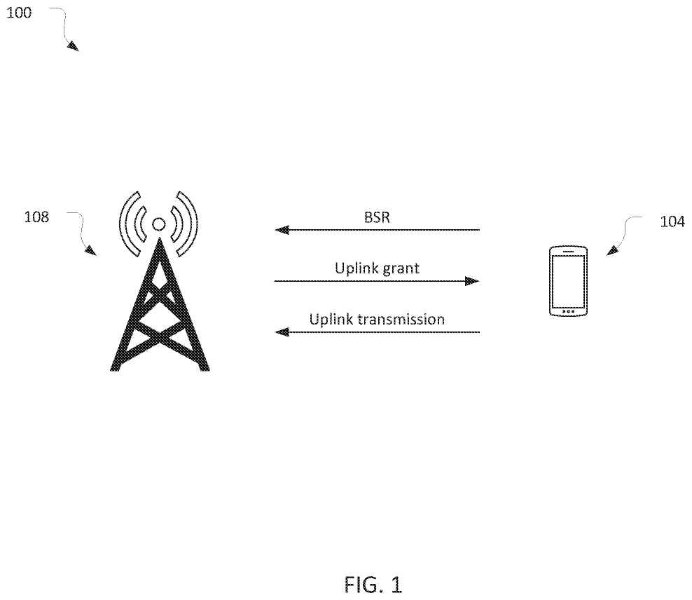

FIG. 1 illustrates a network environment 100 in accordance with some embodiments. The network environment 100 may include a UE 104 coupled with a base station (BS) 108 of a radio access network (RAN). In some embodiments, the base station 108 is a next-generation node B (gNB) that provides one or more 3GPP New Radio (NR) cells. In other embodiments, the base station 108 is an evolved node B (eNB) that provides one or more Long Term Evolution (LTE) cells. The air interface over which the UE 104 and base station 108 communicate may be compatible with 3GPP technical specifications, such as those that define Fifth Generation (5G) NR or later system standards.

The UE 104 may send a buffer status report (BSR) to the base station 108 to indicate an amount of uplink data that UE 104 has to transmit. The BSR may be transmitted as a media access control (MAC) control element (CE) on a physical uplink shared channel (PUSCH). The BSR may be associated with a logical channel group (LCG) having one or more logical channels (LCHs). Upon receiving the BSR, the base station 108 may determine an appropriate amount of uplink resources for the UE 104. The base station 108 may then transmit an uplink grant to the UE 104. The UE 104 may use the UL grant for a subsequent uplink transmission.

In various embodiments, the UE 104 may transmit a regular BSR, a periodic BSR, or a padding BSR. A regular BSR may be triggered in the event new uplink data of an LCH of an LCG becomes available in a MAC buffer and either the LCH has a higher priority than any other LCH having buffered data; or no other LCH has buffered data. A regular BSR may also be triggered in the event a retransmit BSR timer (retxBSR-Timer) expires and an LCH includes buffered data to be transmitted. The retransmit BSR timer may be used to avoid a deadlock situation that may occur if the base station 108 fails to receive a BSR, but the UE 104 believes the BSR transmission was successful. Thus, the retransmit BSR timer provides a limited period of time the UE 104 will wait for the uplink grant before retransmitting the BSR. The retransmit BSR timer is started when a BSR is multiplexed into a MAC protocol data unit (PDU).

A periodic BSR may be triggered upon expiration of a periodic BSR timer (periodicBSR-Timer).

A padding BSR may be triggered if allocated uplink resources have a number of padding bits equal to or exceeding a size of the BSR. Thus, the padding BSR may opportunistically utilize unused uplink capacity.

Existing networks include a number of BSR formats including a short BSR format (fixed size), an extended short BSR format (fixed size), a long BSR format (variable size), an extended long BSR format (variable size), a short truncated BSR format (fixed size), a long truncated BSR format (variable size), and an extended long truncated BSR format (variable size). Selection between these formats in existing networks is fixed in clause 5.4.5 of 3GPP TS 38.321. The selection may be based on a number of LCGs that have data available for transmission, whether the MAC entity has a logical channel group IAB extension (logicalChanelGroup-IAB-Ext) configured, and, for padding BSR, the number of available padding bits compared to the size of various of the formats.

Traffic types are evolving to accommodate new use cases in developing cellular networks. For example, efforts are being undertaken to improve RAN operation to support traffic having characteristics associated with extended reality (XR) traffic to provide, for example, high throughput, low-latency, and high reliability. Various enhancements to BSR operation may be used to improve capacity for XR use cases. While some embodiments are described with reference to XR traffic, other embodiments may apply similar concepts to other types of traffic.

BSR tables having a finer granularity than existing tables may be used to enhance BSR for XR use cases. Existing BSR tables in 3GPP TS 38.321 have a quantization error of the buffer size levels that increases for higher buffer size levels. As packet sizes for XR traffic may be quite large (for example, with reference to a video frame), the quantization error may lead to a degradation of resource efficiency.

The BSR may be enhanced for XR use cases by including additional types of information. Existing BSRs only provide information about a buffer size. In order to facilitate delay-aware scheduling for XR traffic that has latency constraints, the BSR may further include information relating to delay status of the buffered data. For example, the BSR may include an indication of how long the data has been queued or an amount of time that remains until a delivery deadline.

XR traffic may operate based on a PDU set. The PDU set, which may correspond to an application data unit, may include a plurality of packets/PDUs. A user plane function (UPF) may identify a PDU set based on a PDU set sequence number (SN), a start/end PDU of the PDU set, a PDU SN within a PDU set, or a number of PDUs within a PDU set.

A quality of service (QoS) flow may be identified using a QoS flow ID and each PDU set within the QoS flow may be identified using the PDU set SN. Each QoS flow can be used to deliver one or more PDU sets.

The UPF may further identify information relating to the PDU set, for example, a PDU set importance or a PDU set dependency. The UPF may provide the information relating to PDU sets to a RAN.

QoS parameters for PDU set based QoS handling may include a PDU set delay budget (PSDB), a PDU set error rate (PSER), whether to drop a PDU set in case a PSDB is exceeded, whether all PDUs are needed for usage of a PDU set by an application layer, and a PDU set priority.

The characteristics of a buffered PDU set (for example, an importance level of the PDU set) may be indicated in a BSR.

Additional BSR formats and tables may be developed to accommodate the finer granularity buffer size or BSRs including additional information (e.g., delay or queue information). However, transmitting BSRs with the increased granularity or additional information may result in increased signaling overhead.

Prudent consideration may be given to whether these new formats/tables with the increased overhead are needed in all situations. For example, if the buffer size is relatively small, the quantization error using legacy BSR tables may be insignificant. For another example, if an application can still make use of a PDU set even of some of the PDUs are not delivered, the RAN may determine not to make an effort to deliver the PDU set urgently even if a remaining time until the delivery deadline is small. For yet another example, if the buffered data does not have a strict delay constraint, there may be no need to indicate a delay status in the BSR.

Much of the consideration of whether the new formats are tables would be advantageous, may be related to factors such as a RAN loading status, a RAN scheduling strategy, an application transmitting or receiving the traffic, etc. Further, different XR traffic may benefit differently from various information provided by a BSR. For example, a first XR traffic may need finer granularity reporting of buffer levels but not delay information, a second XR traffic may need delay information but not finer granularity reporting of buffer levels, and a third XR traffic may need both delay information and finer granularity reporting of buffer levels. In some instances, this may result in a complicated BSR format selection rule.

As briefly mentioned above, BSR format selection is currently fixed by a 3GPP TS. Thus, such a BSR format selection is not flexible enough to take in the various considerations mentioned above.

Embodiments of the present disclosure provide a flexible BSR framework that considers both traffic characteristics and RAN scheduling strategies. Other embodiments disclose BSR triggering and new BSR types that may based on detecting predetermined triggering events associated with delay-sensitive reports. Still other embodiments disclose canceling triggered BSR events based on packet dropping.

Some embodiments may include a configurable mapping between BSR formats and statuses of buffered data. For example, for each BSR format, the base station 108 may preconfigure one or more conditions in which such a BSR format is to be used.

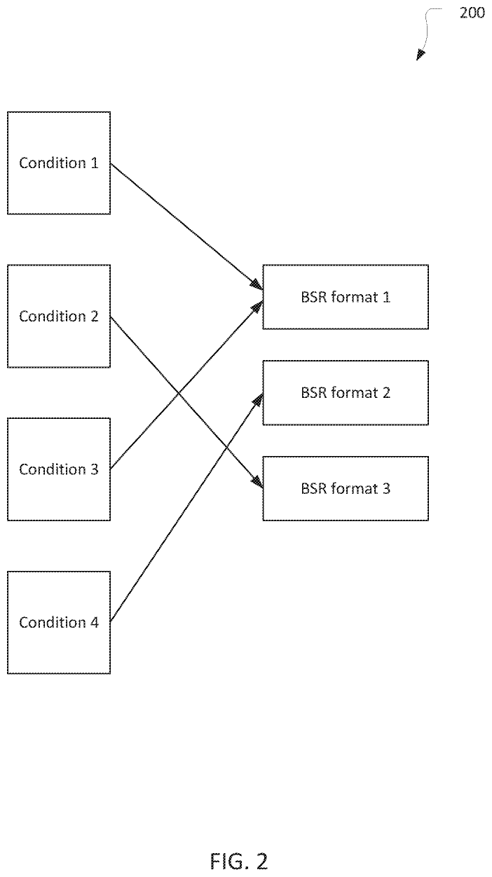

FIG. 2 illustrates an example of a mapping 200 in accordance with some embodiments. The mapping 200 may associate conditions 1-4 with BSR format 1-3. As shown, conditions 1 and 3 may be mapped to BSR format 1; condition 2 may be mapped to BSR format 3, and condition 4 may be mapped to BSR format 2. It will be understood that different embodiments may include different numbers of conditions and BSR formats.

The BSR formats may include any of the existing, legacy BSR formats discussed above. Additionally/alternatively, the BSR formats may include new formats that may be designed for XR traffic, for example.

A new BSR format may include a BSR format with a finer granularity of buffer size levels. In some embodiments, the BSR format with a finer granularity of buffer size levels may correspond to a new table that includes less quantization error for higher buffer levels then that provided by existing tables.

Another new BSR format may include a BSR format with information relating to a delay or queuing status of buffered data.

Another new BSR format may include a BSR format with information relating to characteristics of a buffered PDU set. The characteristics may include, but are not limited to, importance, priority level, or whether all PDUs of the PDU set are required by the application layer.

The new BSR formats may be based on extensions of BSR formats that currently exist in, for example, 3GPP TS 38.321. In other embodiments, other BSR formats may be used.

The conditions may refer to a status of the buffered data. The conditions may be applicable to a only subset of LCHs (for example, at least one LCH of at least one specific LCG). Alternatively, the conditions may be applicable to any LCH of any LCG. The conditions may be one or more of the following.

A first condition may relate to whether all PDUs in a buffered PDU set are needed by an application. For example, if all PDUs in a buffered PDU set are needed by an application, the base station 108 may configure the UE 104 to use a BSR format with queuing delay information. On the contrary, if not all PDUs in a buffered PDU set are needed by an application, the base station 108 may configure the UE 104 to use a BSR format without queuing delay information as it may be that the timely delivery of the PDU set is not as critical

A second condition may relate to whether a remaining time budget until a delivery deadline of buffered data is smaller or larger than a predetermined threshold. For example, if the remaining time budget is less than the predetermined threshold, the base station 108 may configure the UE 104 to use a BSR format with delay/queuing status of buffered data.

A third condition may relate to whether a queuing time of buffered data is smaller or larger than a predetermined threshold. For example, if the queuing time is greater than the predetermined threshold, the base station 108 may configure the UE 104 to use a BSR format with delay/queuing status of buffered data.

A fourth condition may relate to whether a buffered data size is smaller or larger than a predetermined threshold. For example, if the buffered data size is greater than the predetermined threshold, the base station 108 may configure the UE 104 to use a BSR format with a finer granularity for higher buffer size levels.

A fifth condition may relate to whether a buffered PDU set is considered as an “important” or “not important” PDU set. For example, if the buffered PDU set is considered as an “important” PDU set, the base station 108 may configure the UE 104 to use a BSR format with an indication of the PDU set importance.

A sixth condition may relate to whether a buffered PDU set is considered a “low priority” or “high priority” PDU set. For example, if the buffered PDU set is considered as a “high priority” PDU set, the base station 108 may configure the UE 104 to use a BSR format with an indication of the PDU set priority.

A seventh condition may relate to whether packet discarding is configured for a buffered PDU set or its radio bearer or whether the BSR is triggered by an event related to packet discarding. For example, if packet discarding is configured, the base station 108 may configure the UE 104 to use a BSR format with an indication of the packet discarding setting, or a BSR table with quantized remaining time until the delivery deadline of buffered data, such that the base station can know when the packets may be discarded if not delivered.

In some embodiments, a BSR format may include a combination or joint-use of two or more of the formats listed above. For example, the UE 104 may detect a first condition that is associated with a BSR for buffer size and a second condition that is associated with a BSR format for delay information for buffered data (or the UE 104 can detect one condition that is associated with both BSR formats). In this embodiment, a MAC CE having a joint BSR format for buffer size and delay information may be used. Additionally/alternatively, the BSR report may include a plurality of MAC CEs for BSR relating to the buffered data, for example, a first MAC CE with a BSR format for buffer size and a second MAC CE with a BSR format for delay information.

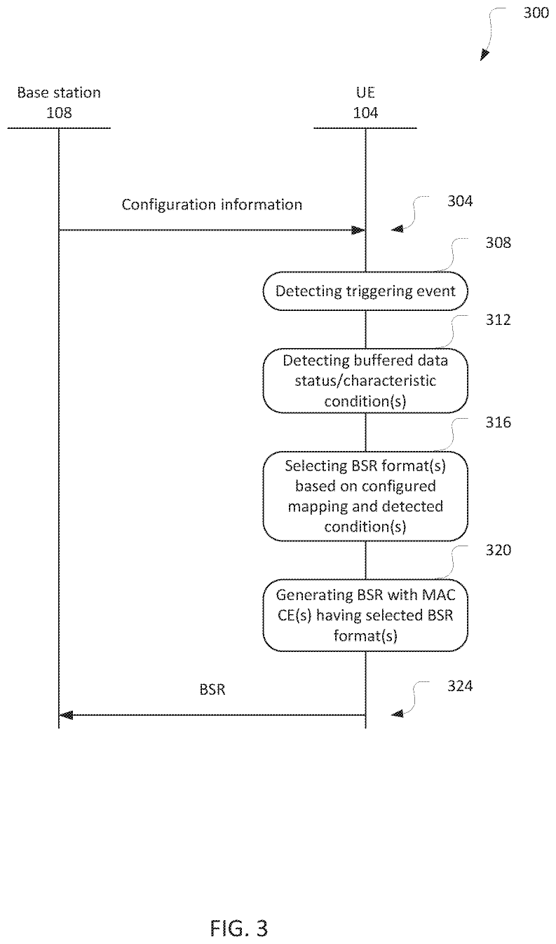

FIG. 3 is a signaling diagram 300 for a BSR in accordance with some embodiments.

The signaling diagram 300 may include, at 304, the base station 108 sending configuration information to the UE 104. The configuration information may configure mapping between conditions and BSR formats. The conditions may be related to buffered data statuses/characteristics.

The signaling diagram 300 may further include, at 308, the UE 104 detecting a BSR triggering event. The BSR triggering event may be similar to that described above. For example, the BSR triggering event may be related to new data becoming available in the buffer, detecting unused uplink resources, or expiration of a periodic BSR timer.

The signaling diagram 300 may further include, at 312, detecting buffered data status/characteristics condition(s). The detected condition(s) may be one or more of the seven conditions described above.

In some instances, operations 308 and 312 may be combined. For example, the BSR triggering event of 308 may be based on the conditions of 312. Thus, the UE may trigger a BSR when the conditions are met.

The signaling diagram 300 may further include, at 316, selecting BSR format(s) based on detected condition(s). The BSR format(s) selected at 316 may be one or more of those described elsewhere herein.

The signaling diagram 300 may further include, at 320, generating a BSR with one or more MAC CEs having the selected BSR format(s).

The signaling diagram 300 may further include, at 324, the UE 104 transmitting the BSR to the base station 108. The BSR may be transmitted in allocated uplink resources. In some embodiments, the uplink resources may be specifically allocated for the BSR based on, for example, a request (e.g., scheduling request) from the UE 104. In other embodiments, the uplink resources may be allocated for another purpose and used opportunistically by the UE 104 for reporting the BSR.

In some embodiments, the detection of the buffered data status/characteristics condition(s) at 312 may not occur immediately after detecting the triggering event at 308 and may be based on a timing of other operations of the signaling diagram 300. For example, in some embodiments, it may be desirable for the conditions to be detected as close in time as possible to the transmission of the BSR at 324. This may ensure that the selected BSR format(s) are the most suitable in light of evolving characteristics of the buffered data. Thus, in some embodiments, the UE 104 may detect the conditions in advance of the uplink resources to be used for the BSR transmission by a time period in which the UE 104 can perform operations 312, 316, and 320.

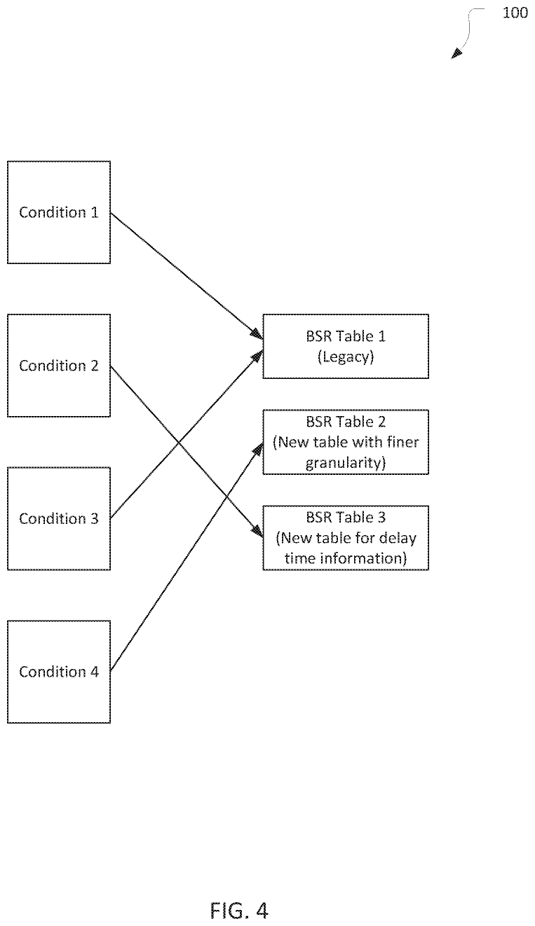

FIG. 4 illustrates an example of a mapping 400 in accordance with some embodiments. The mapping 400 may associate conditions 1-4 with BSR tables 1-3. As shown, conditions 1 and 3 may be mapped to BSR table 1; condition 2 may be mapped to BSR table 3, and condition 4 may be mapped to BSR table 2. It will be understood that different embodiments may include different numbers of conditions and BSR tables.

The BSR table may include an existing, legacy BSR table such as those found in 3GPP TS 38.321. For example, the legacy BSR table may be similar to Table 6.1.3.1-1 of 3GPP TS 38.321 for a five-bit buffer size field or Table 6.1.3.1-2 of 3GPP TS 38.321 for an eight-bit buffer size field. Additionally/alternatively, the BSR table may include a new table designed for XR traffic, for example.

A new BSR table may include a BSR table with a finer granularity of buffer size levels. In some embodiments, the finer granularity may be with respect to granularities exhibited by the higher buffer size levels of the legacy tables. For example, while the legacy BSR tables may have step sizes between adjacent buffer size levels that increase with the buffer size levels, a new BSR table may have constant steps throughout the table or even step sizes that decrease with the buffer size levels in order to complement the existing tables.

Another new BSR table may include indexes that correspond to quantized queuing time values.

Another new BSR table may include indexes that correspond to quantized remaining time until a delivery deadline associated with the buffered data.

Other BSR tables may also be used. The BSR tables may be predefined, for example, by a 3GPP TS, or may be configured by the network.

The conditions may refer to a status of the buffered data. The conditions may be applicable to only a subset of LCHs (for example, at least one LCH of at least one specific LCG). Alternatively, the conditions may be applicable to any LCH of any LCG. The conditions may be one or more of the following.

A first condition may relate to whether all PDUs in a buffered PDU set are needed by an application. For example, if all PDUs in a buffered PDU set are needed by an application, the base station 108 may configure the UE 104 to use a BSR table with queuing delay information. On the contrary, if not all PDUs in a buffered PDU set are needed by an application, the base station 108 may configure the UE 104 to use a legacy BSR table without queuing delay information as it may be that the timely delivery of the PDU set is not as critical.

A second condition may relate to whether a remaining time budget until a delivery deadline of buffered data is smaller or larger than a predetermined threshold. For example, if the remaining time budget is less than the predetermined threshold, the base station 108 may configure the UE 104 to use a BSR table that with quantized remaining time until the delivery deadline of buffered data.

A third condition may relate to whether a queuing time of buffered data is smaller or larger than a predetermined threshold. For example, if the queuing time is greater than the predetermined threshold, the base station 108 may configure the UE 104 to use a BSR table with quantized queuing time of the buffered data.

A fourth condition may relate to whether a buffered data size is smaller or larger than a predetermined threshold. For example, if the buffered data size is greater than the predetermined threshold, the base station 108 may configure the UE 104 to use the BSR table with a finer granularity for higher buffer size levels.

A fifth condition may relate to whether a buffered PDU set is considered as an “important” or “not important” PDU set. For example, if the buffered PDU set is considered as an “important” PDU set, the base station 108 may configure the UE 104 to use a BSR table with explicit or implicit information relating to the importance of the PDU set.

A sixth condition may relate to whether a buffered PDU set is considered a “low priority” or “high priority” PDU set. For example, if the buffered PDU set is considered as a “high priority” PDU set, the base station 108 may configure the UE 104 to use a BSR table with explicit or implicit information relating to the priority of the PDU set.

A seventh condition may relate to whether packet discarding is configured for a buffered PDU set or its radio bearer or whether the BSR is triggered by an event related to packet discarding. For example, if packet discarding is configured, the base station 108 may configure the UE 104 to use a BSR table with quantized remaining time until the delivery deadline of buffered data, such that the base station can know when the when the packets may be discarded if not delivered.

In some embodiments, the selection of the BSR table may be imply the selection of a BSR format. However, in other embodiments, selection of the BSR table and format may be at least partially independent from one another.

In some instances, the UE 104 may need to use two or more tables from those mentioned above. For example, the UE 104 may detect a first condition that is associated with a first BSR table (e.g., a BSR table with finer granularity sizes for higher buffer size levels) and may detect a second condition that is associated with a second BSR table (e.g., a BSR table with a quantized queuing time) (or the UE 104 can detect one condition associated with both BSR tables). In this embodiment, the UE 104 may generate a MAC CE with a first indication corresponding to the first BSR table and a second indication corresponding to the second BSR table. Additionally/alternatively, the UE 104 may generate the BSR to include a plurality of MAC CEs relating to the buffered data, for example, a first MAC CE with a first indication corresponding to the first BSR table and a second MAC CE with a second indication corresponding to the second BSR table.

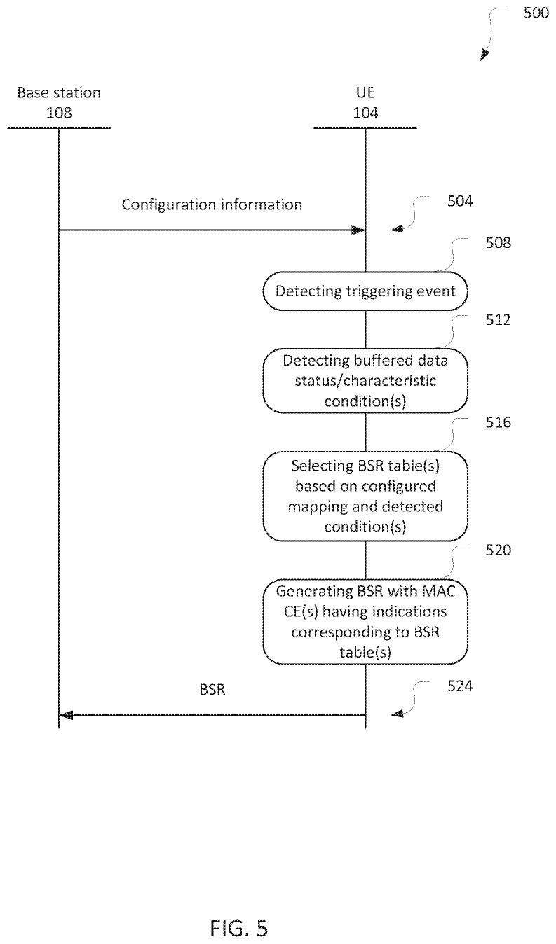

FIG. 5 is a signaling diagram 500 for a BSR in accordance with some embodiments.

The signaling diagram 500 may include, at 504, the base station 108 sending configuration information to the UE 104. The configuration information may configure a mapping between conditions and BSR tables. The conditions may be related to buffered data statuses/characteristics.

The signaling diagram 500 may further include, at 508, the UE 104 detecting a BSR triggering event. The BSR triggering event may be similar to that described above. For example, the BSR triggering event may be related to new data becoming available in the buffer, detecting unused uplink resources, or expiration of a periodic BSR timer.

The signaling diagram 500 may further include, at 512, detecting buffered data status/characteristics condition(s). The detected condition(s) may be one or more of the seven conditions described above.

In some instances, operations 508 and 512 may be combined. For example, the BSR triggering event of 508 may be based on the conditions of 512. Thus, the UE may trigger a BSR when the conditions are met.

The signaling diagram 500 may further include, at 516, selecting BSR table(s) based on detected condition(s). The BSR table(s) selected at 316 may be one or more of those described elsewhere herein.

The signaling diagram 500 may further include, at 520, generating a BSR with one or more MAC CEs having indications corresponding to the selected BSR table(s).

The signaling diagram 500 may further include, at 524, the UE 104 transmitting the BSR to the base station 108. The BSR may be transmitted in allocated uplink resources. In some embodiments, the uplink resources may be specifically allocated for the BSR based on, for example, a request from the UE 104. In other embodiments, the uplink resources may be allocated for another purpose and used opportunistically by the UE 104 for reporting the BSR In some embodiments, the detection of the buffered data status/characteristics condition(s) at 512 may not occur immediately after detecting the triggering event at 508 and may be based on a timing of other operations of the signaling diagram 500. For example, in some embodiments, it may be desirable for the conditions to be detected as close in time as possible to the transmission of the BSR at 524. This may ensure that the selected BSR table(s) are the most suitable in light of evolving characteristics of the buffered data. Thus, in some embodiments, the UE 104 may detect the conditions in advance of the uplink resources to be used for the BSR transmission by a time period in which the UE 104 can perform operations 512, 516, and 520.

In some embodiments, the base station 108 may configure a mapping between BSR timer configurations and various conditions that correspond to statuses of the buffered data. Depending on a condition of the status of the buffered data, the UE 104 may then select a BSR configuration corresponding to different values of BSR-related timers. The BSR-related timers may include, for example, a periodic BSR timer (periodicBSR-Timer), a retransmit BSR timer (retxBSR-Timer), or a logical channel scheduling request delay timer (logicalChannelSR-DelayTimer). The timer values may be configured by RRC in a BSR configuration (BSR-config).

3GPP TS 38.321 describes how and when a UE is to use various BSR-related timers. For example, clause 5.4.5 provides that a MAC entity of a UE is to start or restart the periodicBSR-Timer or retxBSR-Timer in various situations. For example,

The MAC entity shall:
1> if the Buffer Status reporting procedure determines that at least one BSR has been triggered and not cancelled:
2> if UL-SCH resources are available for a new transmission and the UL-SCH resources can accommodate the BSR MAC CE plus its subheader as a result of logical channel prioritization:
3> instruct the Multiplexing and Assembly procedure to generate the BSR MAC CE(s) as defined in clause 6.1.3.1;
3> start or restart periodicBSR-Timer except when all the generated BSRs are long or short Truncated or Extended long or short Truncated BSRs;
3> start or restart retxBSR-Timer.
   3gpp TS 38.321, clause 5.4.5.

In some embodiments, the UE 104 may adaptively change, select, or ignore a BSR-related timer value when a configured condition is met. The configured conditions may be applicable to only a subset of LCHs (for example, at least one LCH of at least one specific LCG). Alternatively, the conditions may be applicable to any LCH of any LCG. The conditions may be one or more of the following.

A first condition may relate to whether all PDUs in a buffered PDU set are needed by an application. For example, if all PDUs in a buffered PDU set are needed by an application, the base station 108 may configure the UE 104 to use a BSR-related timer with a smaller timer value to more quickly trigger the periodic BSR, BSR retransmission, or scheduling request.

A second condition may relate to whether a remaining time budget until a delivery deadline of buffered data is smaller or larger than a predetermined threshold. For example, if the remaining time budget is less than the predetermined threshold, the base station 108 may configure the UE 104 to use a BSR-related timer with a smaller timer value to more quickly trigger the periodic BSR, BSR retransmission, or scheduling request.

A third condition may relate to whether a queuing time of buffered data is smaller or larger than a predetermined threshold. For example, if the queuing time is greater than the predetermined threshold, the base station 108 may configure the UE 104 to use a BSR-related timer with a smaller timer value to more quickly trigger the periodic BSR, BSR retransmission, or scheduling request.

A fourth condition may relate to whether a buffered data size is smaller or larger than a predetermined threshold. For example, if the buffered data size is greater than the predetermined threshold, the base station 108 may configure the UE 104 to use a BSR-related timer with a smaller timer value to more quickly trigger the periodic BSR, BSR retransmission, or scheduling request.

A fifth condition may relate to whether a buffered PDU set is considered as an “important” or “not important” PDU set. For example, if the buffered PDU set is considered as an “important” PDU set, the base station 108 may configure the UE 104 to use a BSR-related timer with a smaller timer value to more quickly trigger the periodic BSR, BSR retransmission, or scheduling request.

A sixth condition may relate to whether a buffered PDU set is considered a “low priority” or “high priority” PDU set. For example, if the buffered PDU set is considered as a “high priority” PDU set, the base station 108 may configure the UE 104 to use a BSR-related timer with a smaller timer value to more quickly trigger the periodic BSR, BSR retransmission, or scheduling request.

A seventh condition may relate to whether packet discarding is configured for a buffered PDU set or its radio bearer or whether the BSR is triggered by an event related to packet discarding. For example, if packet discarding is configured, the base station 108 may configure the UE 104 to use a BSR-related timer with a smaller timer value to more quickly trigger the periodic BSR, BSR retransmission, or scheduling request, in order to prevent packet discarding.

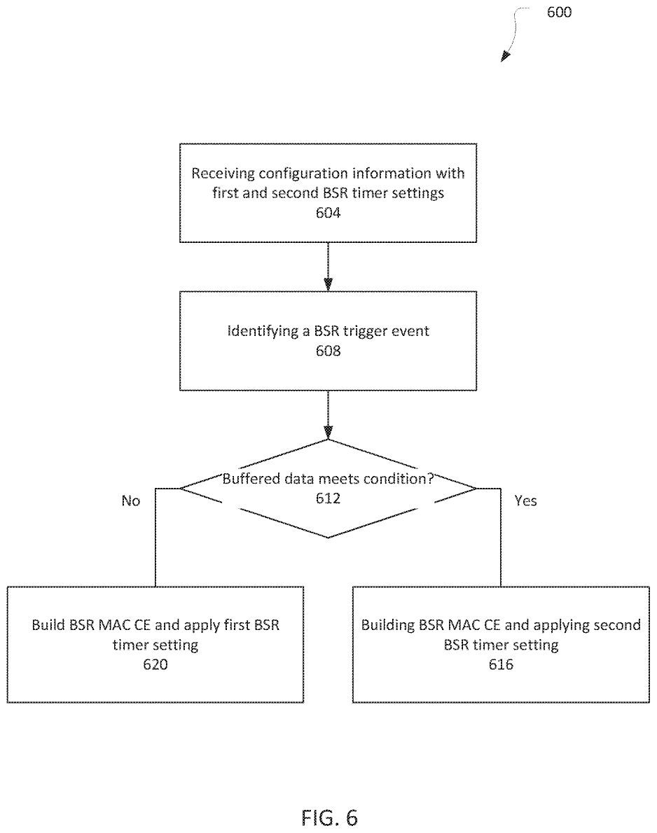

FIG. 6 illustrates an operation flow/algorithmic structure 600 for BSR based on configured mapping between BSR timer configurations in various conditions in accordance with some embodiments. The operation flow/algorithmic structure 600 may be implemented by a UE such as, for example, UE 104 or 1400 or components therein, for example, processing circuitry 1404.

The operation flow/algorithmic structure 600 may include, at 604, receiving configuration information with first and second BSR timer settings. The BSR timer settings may include one or more values corresponding to any of the BSR-related timers discussed herein. In some embodiments, one of the BSR timer settings may be configured as a default setting that is to be used unless the other setting is conditionally triggered. In some embodiments, one or more of the BSR timer settings (for example, default settings) may be predefined by, for example, a 3GPP, while other BSR timer settings (for example, triggered settings) may be dynamically configured by the base station 108.

In some embodiments, the configuration information may include additional/alternative information such as, for example, information about buffer status conditions that are associated with one or more of the BSR timer settings. For purposes of describing the present embodiment, the buffer status condition may be associated with the second BSR timer setting. Thus, in this instance, the first BSR timer setting may be considered as the default BSR timer setting.

The operation flow/algorithmic structure 600 may further include, at 608, identifying a BSR trigger event. The trigger event may be associated with a regular, periodic, or padding BSR as discussed elsewhere herein.

The operation flow/algorithmic structure 600 may further include, at 612, determining whether the buffered data meets the buffer status condition. In the event the buffered data meets the buffer status condition, the operation flow/algorithmic structure 600 may advance to building BSR MAC CE and applying second BSR timer setting at 616.

In some instances, operations 608 and 612 may be combined. For example, the BSR triggering event of 608 may be based on the conditions of 612. Thus, the UE may trigger a BSR when the conditions are met.

In the event the buffered data does not meet the buffer status condition, the operation flow/algorithmic structure 600 may advance to building the BSR MAC CE and applying the first BSR timer setting at 620.

In some embodiments, the BSR MAC CE generated and transmitted in a BSR may include an information type indicator to indicate the type of information that is included in the BSR MAC CE. The information type may refer to, for example, the BSR table upon which the BSR MAC CE is based (for example, legacy BSR table or BSR table with finer granularity at higher BSR levels); presence of queueing/delay information in the BSR MAC CE; or presence of PDU set characteristic information in the BSR MAC CE.

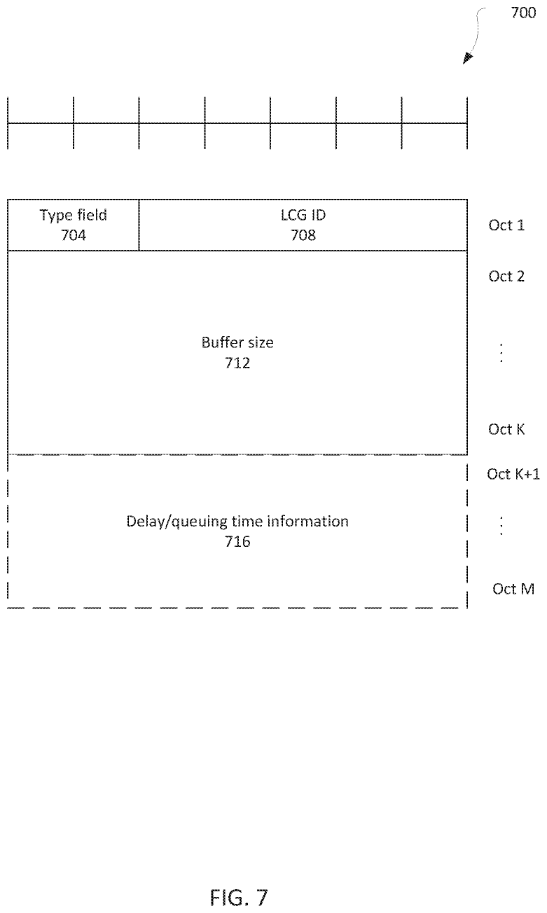

FIG. 7 includes a BSR MAC CE 700 in accordance with some embodiments. The UE 104 may generate the BSR MAC CE 700 for a BSR that is to be transmitted to the base station 108.

The BSR MAC CE 700 may include M octets. In a first octet, the BSR MAC CE 700 may include a type field 704 and an LCG identifier 708. The type field 704 may indicate a type of information that is to be included. The LCG identifier 708 may identify the LCG to which the BSR relates.

The BSR MAC CE 700 may further include a buffer size 712. The buffer size may be indicated using one or more octets and may indicate a size of a buffer of the UE 104. As shown, the buffer size 712 is from the second octet to the Kth octet.

In some embodiments, the BSR MAC CE 700 may further include delay/queuing information 716. The delay/queuing information 716 may provide information about a delay or queuing status of the buffered data, or remaining time until the delivery deadline of the buffered data.

Upon decoding the type field 704, the base station 108 may determine the type of information included in the BSR MAC CE 700. In some embodiments, the type field 704 may be a one bit field that indicates whether delay/queuing information is present in the BSR MAC CE 700. In other embodiments, the type field 704 may include one or more bits to provide an indication of whether the BSR MAC CE 700 includes additional/alternative buffer related data (for example, PDU set characteristics, finer granularity sized reporting, etc.). The type field 704 may be any number of bits needed to provide an indication of the type of information conveyed.

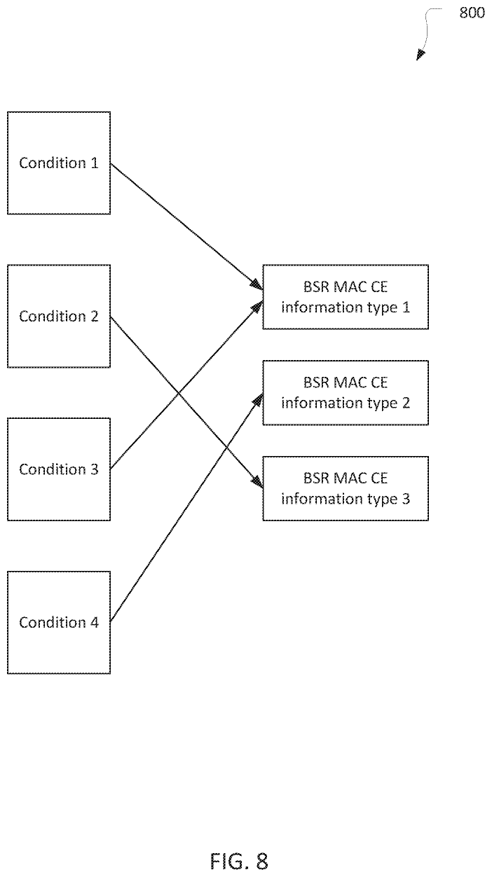

FIG. 8 illustrates an example of a mapping 800 in accordance with some embodiments. The mapping 800 may associate conditions 1-4 with BSR MAC CE information types 1-3. As shown, conditions 1 and 3 may be mapped to BSR MAC CE information type 1; condition 2 may be mapped to BSR MAC CE information type 3, and condition 4 may be mapped to BSR MAC CE information type 2. It will be understood that different embodiments may include different numbers of conditions and BSR MAC CE information types. The conditions may be similar to those discussed elsewhere herein.

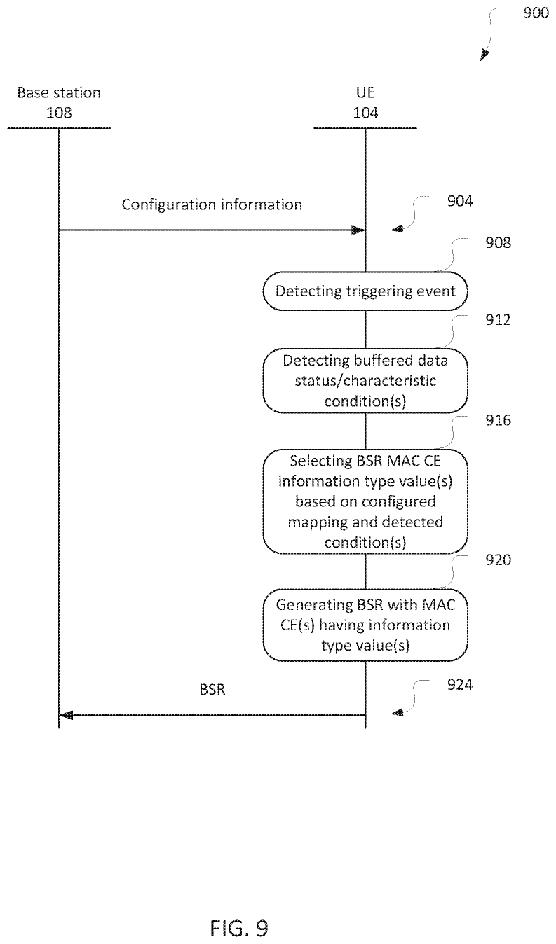

FIG. 9 is a signaling diagram 900 for a BSR in accordance with some embodiments.

The signaling diagram 900 may include, at 904, the base station 108 sending configuration information to the UE 104. The configuration information may configure mapping between conditions and BSR MAC CE information type values. The conditions may be related to buffered data statuses/characteristics.

The signaling diagram 900 may further include, at 908, the UE 104 detecting a BSR triggering event. The BSR triggering event may be similar to that described above. For example, the BSR triggering event may be related to new data becoming available in the buffer, detecting unused uplink resources, or expiration of a periodic BSR timer.

The signaling diagram 900 may further include, at 912, detecting buffered data status/characteristics condition(s). The detected condition(s) may be one or more of the seven conditions described above.

The signaling diagram 900 may further include, at 916, selecting BSR MAC CE information type value(s) based on detected condition(s). The BSR MAC CE information type value(s) selected at 916 may be one or more of those described elsewhere herein.

The signaling diagram 900 may further include, at 920, generating a BSR with one or more MAC CEs having the selected information type value(s).

The signaling diagram 900 may further include, at 924, the UE 104 transmitting the BSR to the base station 108. The BSR may be transmitted in allocated uplink resources. In some embodiments, the uplink resources may be specifically allocated for the BSR based on, for example, a request from the UE 104. In other embodiments, the uplink resources may be allocated for another purpose and used opportunistically by the UE 104 for reporting the BSR.

In some embodiments, the detection of the buffered data status/characteristics condition(s) at 912 may not occur immediately after detecting the triggering event at 908 and may be based on a timing of other operations of the signaling diagram 900. For example, in some embodiments, it may be desirable for the conditions to be detected as close in time as possible to the transmission of the BSR at 924. This may ensure that the selected information type value(s) are the most suitable in light of evolving characteristics of the buffered data. Thus, in some embodiments, the UE 104 may detect the conditions in advance of the uplink resources to be used for the BSR transmission by a time period in which the UE 104 can perform operations 912, 916, and 920.

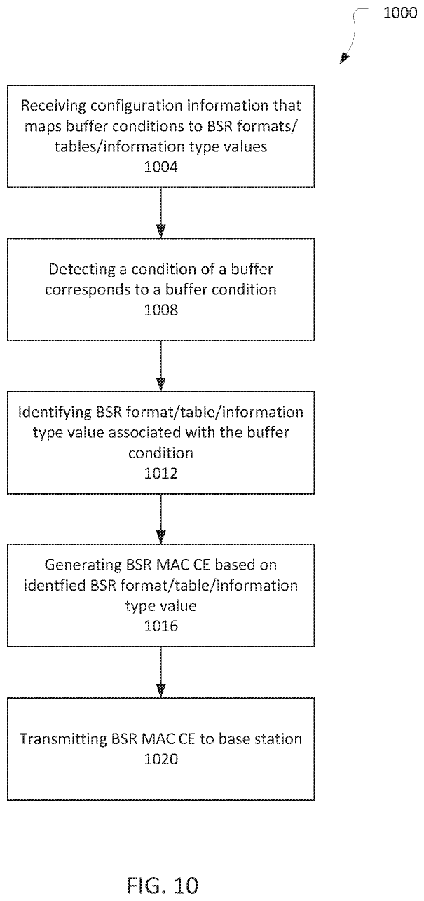

FIG. 10 is an operation flow/algorithmic structure 1000 in accordance with some embodiments. The operation flow/algorithmic structure 1000 may be implemented by a MAC entity in a UE (for example, UE 104 or UE 1400) or components therein, for example, processing circuitry 1404.

The operation flow/algorithmic structure 1000 may include, at 1004, receiving configuration information that maps buffer conditions to BSR formats, tables, or information type values. The configured mapping may be similar to that described elsewhere herein. The BSR formats, tables, or information type values may be interrelated or independent from one another. For example, in some embodiments, a buffer status condition may map to a BSR format, table, and information type value, while, in other embodiments, a buffer status condition may map only to a BSR format, only to a table, or only to an information type value.

In some embodiments, the mapping of buffer conditions to BSR formats, tables, or information type values may be determined in other ways. For example, the mapping may be predefined by, for example, a 3GPP TS.

The operation flow/algorithmic structure 1000 may further include, at 1008, detecting a condition of a buffer that corresponds to a buffer condition mapped to a BSR format/table/information type value. In some embodiments, the buffer condition may be mapped to more than one BSR format/table/information type value. The condition may be similar to any of those discussed elsewhere herein. In some embodiments, the UE may detect a plurality of conditions that mapped to a plurality of BSR formats/tables/information type values.

The operation flow/algorithmic structure 1000 may further include, at 1012, identifying a BSR format/table/information type value associated with the buffer condition.

The operation flow/algorithmic structure 1000 may further include, at 1016, generating a BSR MAC CE based on the identified BSR format/table/information type value.

The operation flow/algorithmic structure 1000 may further include, at 1020, transmitting the BSR MAC CE to the base station. In some embodiments, the BSR MAC CE may include information that corresponds to a plurality of detected buffer status conditions. In other embodiments, the BSR MAC CE may be included in a BSR with one or more additional BSR MAC CEs that correspond to one or more additional detected buffer status conditions.

As briefly discussed above, there may be some instances in which all PDUs of a PDU set are not needed for an application layer to use the PDU set. This may result in a situation in which some packets of a PDU set are discarded before they are ever transmitted. This may be based on QoS parameters that indicate whether to drop a PDU set in case a PSDB is exceeded; or whether all PDUs are needed for the usage of a PDU set by an application layer.

Proactive packet dropping may occur in one or more of the following instances.

In a first instance, proactive packet dropping may occur if all packets in a PDU set are required to be successfully delivered in order for an application to utilize the PDU set and at least one of the packets has failed. In this case, it may not be necessary to transmit the remaining packets of the PDU set and, therefore, they may be proactively dropped.

In a second instance, proactive packet dropping may occur if at least one critical/essential packet of a PDU set has failed. In this case, there may be no need to transmit the remaining packets of the PDU set.

In a third instance, proactive packet dropping may occur if a packet layer only needs a certain portion of a PDU set and that portion has been successfully received. In this case, the transmitter may drop the remaining packets in the PDU set in order to save power/resources.

In a fourth instance, proactive packet dropping may be based on an inter-dependent relationship between different PDU sets. The transmitter may determine whether to drop a PDU set or continue to transmit the PDU set based on a status of a related PDU set. For example, if transmission of a first PDU set is essential (for example, is an I frame), the transmitter may determine whether that PDU set is transmitted successfully before continuing to transmit dependent PDU sets (for example, related P frames).

In a fifth instance, a transmitter may use proactive packet dropping in order to alleviate traffic congestion.

When a decision of packet discarding is made, regardless of the cause, the packets from one or more PDU sets that are still queued in a logical channel buffer may be flushed away. In this event, packet discarding may cause a change to the uplink buffer status, for example, the uplink buffer may become empty or at least less full. It may be desirable for the UE to provide the network with a timely indication of the change in the buffer status. Thus, packet discarding may be associated with a BSR triggering event.

Often, XR traffic may be delay sensitive and may include requirements for delivery within a certain time budget (for example, PSDB) in order to make it useful for the receiving application. As discussed above, in order to achieve delay-aware scheduling, BSR reporting may be enhanced to include information such as queuing delay time or remaining time until the delivery deadline. This information may allow the base station 108 to allocate uplink resources in a more timely manner. BSR triggering events related to queuing time, such as those described herein, may allow a BSR including queuing delay information to be triggered when the buffered data has been waiting in the buffer for more than a certain amount of time.

Thus, as described, a number of new BSR triggering events may be introduced based on packet discarding, long queuing delays, and other PDU set characteristics related to, for example, XR use-cases. Embodiments provide processes in which the UE 104 sends BSRs triggered by such events to the base station 108 in order to timely update the buffer status. These BSRs may be transmitted as soon as they are triggered to achieve a more efficient resource allocation. Existing BSR mechanisms impose limits on triggering or transmitting BSRs based on delay timers such as the retransmission BSR timer, the periodic BSR timer, and the logical channel SR delay timer. Embodiments of the present disclosure describe mechanisms to facilitate more rapid transmissions of BSRs that are triggered by predetermined triggering events. The predetermined triggering events may relate to XR-related characteristics such as packet discarding, long queuing delays, etc.

As discussed above, BSRs of certain types may be restricted by a running timer. For example, there may be instances in which a regular BSR may not be transmitted if the retransmit BSR timer is running. Various embodiments describe predetermined triggering events that, if detected by the UE 104, permit the UE 104 to consider a running delay timer that would otherwise restrict transmission of a triggered BSR or related SR to be expired. To consider the delay timer expired, the UE 104 may either affirmatively stop the timer before its natural expiration or may simply ignore the restriction of transmitting the BSR/SR while the timer is running. The “natural expiration” of a timer, as used herein, refers to the expiration of the timer based on a passage of time at least equal to a value of the timer.

In various embodiments, the delay timer that would otherwise restrict transmission of a triggered BSR or related SR may be a retransmit BSR timer, a periodic BSR timer, or a logical channel SR delay timer.

The predetermined triggering events associated with an uplink transmit buffer that may trigger a BSR or cause the UE 104 to consider a running delay timer expired may include the following.

A first triggering event may be detected when packet discarding occurs for one or more logical channels in a logical channel group. In some embodiments, packet discarding may be a triggering event if the quantity of data discarded from the buffer is greater than a predetermined threshold. In other embodiments, the packet discarding may be a triggering event if a level of the buffer becomes less than a predetermined threshold as a result of the packet discarding.

A second triggering event may be detected when a queuing delay time for data buffered for one or more logical channels of a logical channel group exceeds a predetermined threshold.

A third triggering event may be detected when a remaining time until a delivery deadline for data buffered for one or more logical channels of a logical channel group is lower than a predetermined threshold.

A fourth triggering event may be detected when a size of the buffer exceeds a predetermined threshold.

A fifth triggering event may be detected when a PDU set for a logical channel arrives in the buffer and has an importance level or priority level higher than any other buffered PDU set for the logical channel.

A sixth triggering event may be detected when a number of PDUs in a buffered PDU set is higher than a predetermined threshold.

A seventh triggering event may be detected when a data burst with a size larger than a predetermined threshold arrives in the buffer. A data burst, as used herein, may refer to a set of data provided by an application in a short period of time. The set of data may include PDUs from one or more PDU sets.

The predetermined thresholds used in the various triggering events may be predefined by, for example, a 3GPP TS, or may be dynamically configured by the base station 108. Configuration of the predetermined thresholds may be through RRC or MAC signaling.

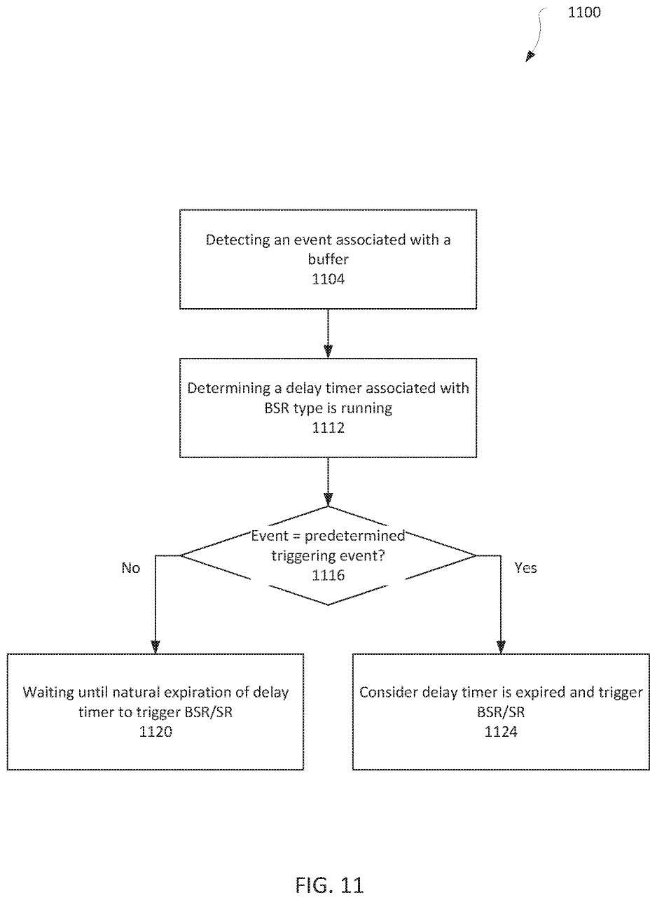

FIG. 11 is an operational flow/algorithmic structure 1100 in accordance with some embodiments. The operational flow/algorithmic structure 1100 may be implemented by a MAC entity in a UE (for example, UE 104 or UE 1400) or components therein, for example, processors 1404.

The operational flow/algorithmic structure 1100 may include, at 1104, detecting an event associated with a buffer. The event may include a change of buffer conditions. For example, the event may relate to new uplink data being added to the buffer, uplink data being removed from the buffer, or a change in timing statuses with respect to uplink data within the buffer.

The operational flow/algorithmic structure 1100 may further include, at 1112, determining a delay timer associated with a BSR type is running.

Some types of BSRs may be associated with delay timers while others may not be associated with delay timers. For example, a BSR not associated with a delay timer may occur if triggered by uplink data for a logical channel of a logical channel group becoming available in the buffer and either: the logical channel has a higher priority than any other logical channel with available uplink data; or no other logical channels of the logical channel group contain available uplink data. Another BSR not associated with the delay timer may be triggered when conditions allow for a padding BSR to be transmitted as discussed elsewhere herein. However, other generated BSRs may be associated with a delay timer and may only be triggered upon expiration of the associated delay timer. For example, retransmission of a regular BSR for data existing in a buffer may be restricted by the retransmit BSR timer. For another example, transmission of a periodic BSR timer may be restricted by the periodic BSR timer. And still another example, transmission of an SR for a regular BSR for a logical channel having the logicalChannelSr-DelayTimer Applied set to true may be restricted by the logical channel SR delay timer.

The operational flow/algorithmic structure 1100 may further include, at 1116, determining whether the event detected at 1104 is a predetermined triggering event. The predetermined triggering event may be any one of the seven predetermined triggering events described above.

While the present embodiment describes detecting one event associated with a buffer and determining whether that event equals a predetermined triggering event, other embodiments may include detecting a plurality of event associated with the buffer and determining whether the plurality of detected events equals a specific combination of a plurality of predetermined triggering events selected from the seven predetermined triggering events.

If it is determined, at 1116, that the detected event does not equal the predetermined triggering event, the operational flow/algorithmic structure 1100 may advance to waiting until natural expiration of the delay timer to trigger a BSR/SR of the BSR type at 1120. Thus, in this instance, the natural expiration of the delay timer may act as the trigger for transmission of the BSR/SR.

If it is determined, at 1116, that the detected event equals the predetermined triggering event, the operational flow/algorithmic structure 1100 may advance to considering the delay timer to be expired and triggering the BSR/SR at 1124. In this manner, further delay of the time-sensitive BSR transmission may be avoided.

As described elsewhere herein, existing 3GPP specifications define three general BSR types, e.g., regular BSR, periodic BSR, and padding BSR. In some embodiments, a new type of BSR may be defined to accommodate delay-sensitive BSR transmissions.

The new type of BSR may be referred to as a delay-sensitive BSR and may have precedence over regular BSRs, periodic BSRs, and padding BSRs. In some embodiments, the delay-sensitive BSR may be considered a special type of regular BSR.

The delay-sensitive BSR or its associated SR may be triggered without considering whether a delay timer (for example, a retransmission BSR timer, a periodic BSR timer, or a logical channel SR delay timer) is running. Thus, the delay-sensitive BSR may not be associated with a delay timer at all.

The delay-sensitive BSR may be triggered by one or more of the seven predetermined triggering events described above.

In some embodiments, to accommodate the delay-sensitive BSR, clause 5.4.5 of 3GPP TS 38.321 may be updated with the underlined portions as follows:

A BSR shall be triggered if any of the following events occur for activated cell group:
UL data, for a logical channel which belongs to an LCG, becomes available to the MAC entity; and either
   this UL data belongs to a logical channel with higher priority than the priority of any logical channel containing available UL data which belong to any LCG; or
   none of the logical channels which belong to an LCG contains any available UL data.
   in which case the BSR is referred below to as ‘Regular BSR’;
UL resources are allocated and number of padding bits is equal to or larger than the size of the Buffer Status Report MAC CE plus its subheader, in which case the BSR is referred below to as ‘Padding BSR’;
Packet discarding occurs for one or more LCHs in a LCG. queueing delay time for data buffered in one or more LCHs in a LCG exceeds a threshold, the remaining delivery deadline for data buffered in one or more LCHs in a LCG is lower than a threshold, the buffer size exceeds a threshold, an important or high priority PDU set has arrived in the buffer, the number of PDUs in the buffered PDU set is higher than a threshold, or a data burst with size larger than a threshold has arrived in the buffer, in which case the BSR is referred below to as ‘Delay-sensitive BSR’;
retxBSR-Timer expires, and at least one of the logical channels which belong to an LCG contains UL data, in which case the BSR is referred below to as ‘Regular BSR’;
periodicBSR-Timer expires, in which case the BSR is referred below to as ‘Periodic BSR’.

Clause 5.4.5 of 3GPP TS 38.321 may also be updated as follows to account for the precedence of the delay-sensitive BSR: “A MAC PDU shall contain at most one BSR MAC CE, even when multiple events have triggered a BSR. The Delay-sensitive BSR shall have precedence over the Regular BSR, Periodic BSR, and padding BSR. The Regular BSR and the Periodic BSR shall have precedence over the padding BSR.”

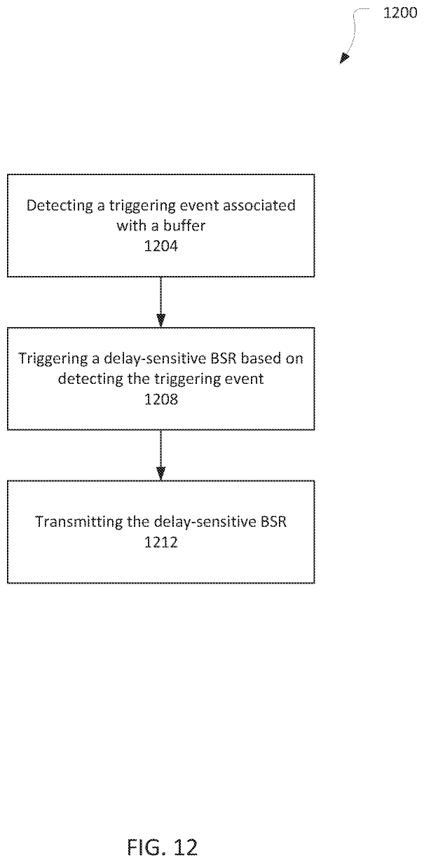

FIG. 12 is an operational flow/algorithmic structure 1200 in accordance with some embodiments. The operational flow/algorithmic structure 1200 may be implemented by a MAC entity in a UE (for example, UE 104 or UE 1400) or components therein, for example, processors 1404.

The operational flow/algorithmic structure 1200 may include, at 1204, detecting a triggering event associated with a buffer. The triggering event may include one or more of the seven predetermined triggering events described elsewhere herein.

The operational flow/algorithmic structure 1200 may further include, at 1208, triggering a delay-sensitive BSR based on detecting the triggering event. The delay-sensitive BSR may be a new type of BSR that is not associated with a delay timer. The delay-sensitive BSR may have precedence over the regular BSR, periodic BSR, and padding BSR as discussed above.

The operational flow/algorithmic structure 1200 may further include, at 1212, transmitting the delay-sensitive BSR. As the delay-sensitive BSR is not associated with a delay timer and has precedence over other BSRs, its transmission may be performed without delay, resulting in a timely delivery of the relevant information.

In some embodiments, packet discarding may be used as a basis for canceling a previously-triggered BSR. For example, a BSR may be originally triggered as UL data for a logical channel that belongs to an LCG becomes available. However, packet discarding may occur in the UL data for the logical channel even before the triggered BSR is transmitted on a MAC PDU. The event that has triggered this BSR may no longer be valid when the buffer becomes empty due to packet discarding (e.g., the UL data is no longer available), and therefore the triggered BSR can be canceled. However, at the same time another BSR may be triggered due to packet discarding in accordance with some embodiments as described earlier.

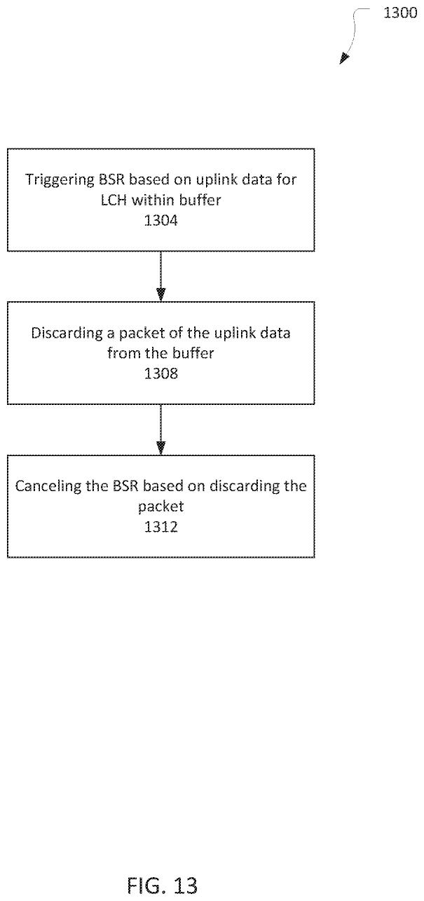

FIG. 13 is an operational flow/algorithmic structure 1300 describing cancelation of a triggered BSR in accordance with some embodiments. The operational flow/algorithmic structure 1300 may be implemented by a MAC entity in a UE (for example, UE 104 or UE 1400) or components therein, for example, processors 1404.

The operational flow/algorithmic structure 1300 may include, at 1304, triggering a BSR based on uplink data for a logical channel within a buffer. The BSR may be triggered based on any of the triggering events described herein. The triggering events may be related to the seven predetermined triggering events or any other triggering event described herein.

The operational flow/algorithmic structure 1300 may further include, at 1308, discarding a packet of the uplink data from the buffer. The packet may be discarded as a result of a proactive packet dropping operation as described elsewhere herein.

The operational flow/algorithmic structure 1300 may further include, at 1312, canceling the BSR based on discarding the packet. In some embodiments, the UE may also stop a delay timer that is associated with the BSR based on canceling the BSR.

In some embodiments, the triggered BSR may be canceled if the buffer of one or more LCHs/LCGs become empty after packet discarding. Otherwise, if the buffer of one or more LCHs/LCGs is not empty after packet discarding, the triggered BSR may not be cancelled.

In some embodiments, the BSR may be canceled in the event that an aggregated size of one or more packets discarded from the buffer is greater than a predetermined threshold size. In other embodiments, the BSR may be canceled if a buffer size becomes less than a predetermined threshold as a result of the one or more packets being discarded from the buffer.

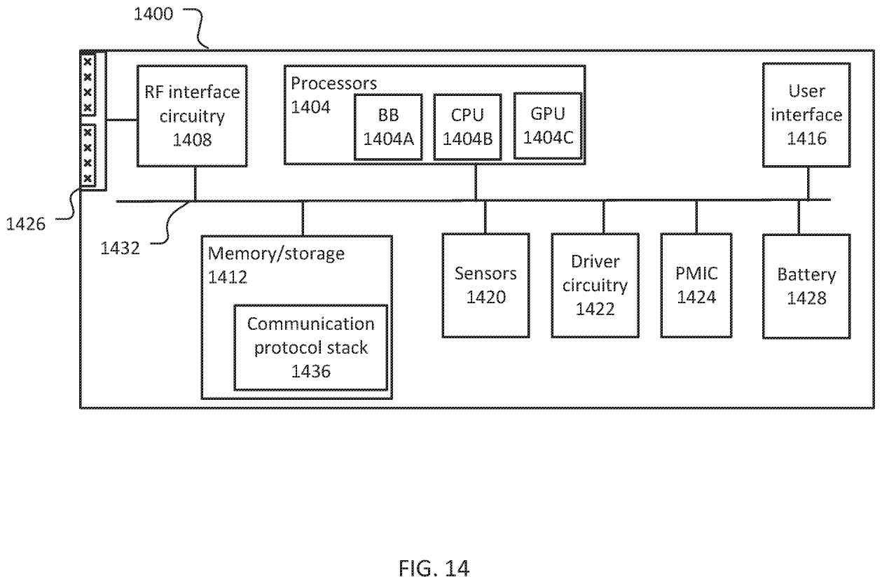

FIG. 14 illustrates a UE 1400 in accordance with some embodiments. The UE 1400 may be similar to and substantially interchangeable with UE 104 of FIG. 1.

The UE 1400 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smart watch), or Internet-of-things device.

The UE 1400 may include processors 1404, RF interface circuitry 1408, memory/storage 1412, user interface 1416, sensors 1420, driver circuitry 1422, power management integrated circuit (PMIC) 1424, antenna structure 1426, and battery 1428. The components of the UE 1400 may be implemented as integrated circuits (ICs), portions thereof, discrete electronic devices, or other modules, logic, hardware, software, firmware, or a combination thereof. The block diagram of FIG. 14 is intended to show a high-level view of some of the components of the UE 1400. However, some of the components shown may be omitted, additional components may be present, and different arrangement of the components shown may occur in other implementations.

The components of the UE 1400 may be coupled with various other components over one or more interconnects 1432, which may represent any type of interface, input/output, bus (local, system, or expansion), transmission line, trace, or optical connection that allows various circuit components (on common or different chips or chipsets) to interact with one another.

The processors 1404 may include processor circuitry such as, for example, baseband processor circuitry (BB) 1404A, central processor unit circuitry (CPU) 1404B, and graphics processor unit circuitry (GPU) 1404C. The processors 1404 may include any type of circuitry or processor circuitry that executes or otherwise operates computer-executable instructions, such as program code, software modules, or functional processes from memory/storage 1412 to cause the UE 1400 to perform operations as described herein.

In some embodiments, the baseband processor circuitry 1404A may access a communication protocol stack 1436 in the memory/storage 1412 to communicate over a 3GPP compatible network. In general, the baseband processor circuitry 1404A may access the communication protocol stack 1436 to: perform user plane functions at a PHY layer, MAC layer, RLC sublayer, PDCP sublayer, SDAP sublayer, and upper layer, and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 1408.

The baseband processor circuitry 1404A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1412 may include one or more non-transitory, computer-readable media that includes instructions (for example, communication protocol stack 1436) that may be executed by one or more of the processors 1404 to cause the UE 1400 to perform various operations described herein. The memory/storage 1412 include any type of volatile or non-volatile memory that may be distributed throughout the UE 1400. In some embodiments, some of the memory/storage 1412 may be located on the processors 1404 themselves (for example, L1 and L2 cache), while other memory/storage 1412 is external to the processors 1404 but accessible thereto via a memory interface. The memory/storage 1412 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1408 may include transceiver circuitry and radio frequency front module (RFEM) that allows the UE 1400 to communicate with other devices over a radio access network. The RF interface circuitry 1408 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 1426 and proceed to filter and amplify (with a low-noise amplifier) the signal. The signal may be provided to a receiver of the transceiver that down-converts the RF signal into a baseband signal that is provided to the baseband processor of the processors 1404.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 1426.

In various embodiments, the RF interface circuitry 1408 may be configured to transmit/receive signals in a manner compatible with NR access technologies.

The antenna structure 1426 may include antenna elements to convert electrical signals into radio waves to travel through the air and to convert received radio waves into electrical signals. The antenna elements may be arranged into one or more antenna panels. The antenna structure 1426 may have antenna panels that are omnidirectional, directional, or a combination thereof to enable beamforming and multiple input, multiple output communications. The antenna structure 1426 may include microstrip antennas, printed antennas fabricated on the surface of one or more printed circuit boards, patch antennas, or phased array antennas. The antenna structure 1426 may have one or more panels designed for specific frequency bands including bands in FR1 or FR2.

The user interface 1416 includes various input/output (I/O) devices designed to enable user interaction with the UE 1400. The user interface 1416 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1400.

The sensors 1420 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1422 may include software and hardware elements that operate to control particular devices that are embedded in the UE 1400, attached to the UE 1400, or otherwise communicatively coupled with the UE 1400. The driver circuitry 1422 may include individual drivers allowing other components to interact with or control various I/O devices that may be present within, or connected to, the UE 1400. For example, the driver circuitry 1422 may include circuitry to facilitate coupling of a UICC (for example, UICC 148) to the UE 1400. For additional examples, driver circuitry 1422 may include a display driver to control and allow access to a display device, a touchscreen driver to control and allow access to a touchscreen interface, sensor drivers to obtain sensor readings of sensors 1420 and control and allow access to sensors 1420, drivers to obtain actuator positions of electro-mechanic components or control and allow access to the electro-mechanic components, a camera driver to control and allow access to an embedded image capture device, audio drivers to control and allow access to one or more audio devices.

The PMIC 1424 may manage power provided to various components of the UE 1400. In particular, with respect to the processors 1404, the PMIC 1424 may control power-source selection, voltage scaling, battery charging, or DC-to-DC conversion.

In some embodiments, the PMIC 1424 may control, or otherwise be part of, various power saving mechanisms of the UE 1400 including DRX as discussed herein.

A battery 1428 may power the UE 1400, although in some examples the UE 1400 may be mounted deployed in a fixed location, and may have a power supply coupled to an electrical grid. The battery 1428 may be a lithium ion battery, a metal-air battery, such as a zinc-air battery, an aluminum-air battery, a lithium-air battery, and the like. In some implementations, such as in vehicle-based applications, the battery 1428 may be a typical lead-acid automotive battery.

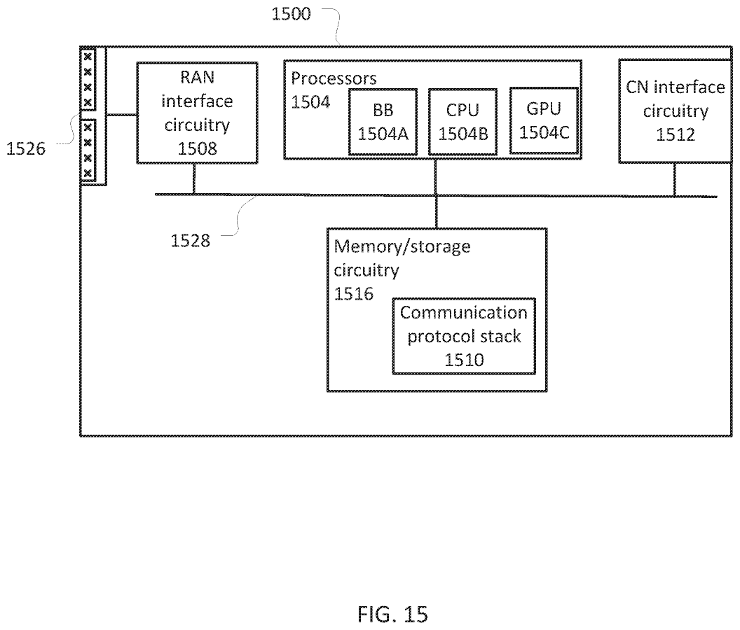

FIG. 15 illustrates a network node 1500 in accordance with some embodiments. The network node 1500 may be similar to and substantially interchangeable with base station 108 or a server in a core network or external data network.

The network node 1500 may include processors 1504, RF interface circuitry 1508 (if implemented as an access node), core network (CN) interface circuitry 1512, memory/storage circuitry 1516, and antenna structure 1526.

The components of the network node 1500 may be coupled with various other components over one or more interconnects 1528.

The processors 1504, RF interface circuitry 1508, memory/storage circuitry 1516 (including communication protocol stack 1510), antenna structure 1526, and interconnects 1528 may be similar to like-named elements shown and described with respect to FIG. 14.

The CN interface circuitry 1512 may provide connectivity to a core network, for example, a 5th Generation Core network (5GC) using a 5GC-compatible network interface protocol such as carrier Ethernet protocols, or some other suitable protocol. Network connectivity may be provided to/from the network node 1500 via a fiber optic or wireless backhaul. The CN interface circuitry 1512 may include one or more dedicated processors or FPGAs to communicate using one or more of the aforementioned protocols. In some implementations, the CN interface circuitry 1512 may include multiple controllers to provide connectivity to other networks using the same or different protocols.

In some embodiments, the network node 1500 may be coupled with transmit receive points (TRPs) using the antenna structure 1526, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary aspects are provided.

Example 1 includes a method of operating a user equipment (UE), the method comprising: determining a mapping of a plurality of buffer conditions to one or more buffer status report (BSR) formats; detecting a condition of a buffer of the UE that corresponds to a first buffer condition of the plurality of buffer conditions; selecting, based on the mapping, a BSR format of the one or more BSR formats that is associated with the first buffer condition; generating a BSR media access control (MAC) control element (CE) with the BSR format; and transmitting the BSR MAC CE to a base station.

Example 2 includes the method of example 1 or some other example herein, further comprising: receiving configuration information from the base station; and determining the mapping based on the configuration information.

Example 3 includes the method of example 1 or some other example herein, wherein the first buffer condition is based on a determination of whether all protocol data units (PDUs) in a buffered PDU set are required by an application.

Example 4 includes the method of example 1 or some other example herein, wherein the first buffer condition is based on a comparison of a remaining time until a delivery deadline of buffered data to a predetermined threshold.

Example 5 includes a method of example 1 or some other example herein, wherein the first buffer condition is based on a comparison of the queuing time of buffered data to a predetermined threshold.

Example 6 includes a method of example 1 or some other example herein, wherein the first buffer condition is based on a comparison of an amount of buffered data to a predetermined threshold.

Example 7 includes the method of example 1 or some other example herein, wherein the first buffer condition is based on an importance or priority associated with a buffered protocol data unit (PDU) set.

Example 8 includes the method of example 1 or some other example herein, wherein the first buffer condition is based on whether packet discarding is configured for a buffered PDU set or a radio bearer corresponding to the buffered PDU set.

Example 9 includes the method of any one of examples 1-8 or some other example herein, wherein the buffer includes traffic for one or more logical channels (LCHs) of one or more logical channel groups (LCGs) and the buffer condition is associated with one or more LCHs of the plurality of LCHs or is associated with any of the plurality of LCHs.

Example 10 includes the method of example 1 or some other example herein, wherein the condition is a first condition, the BSR format is a first BSR format, the BSR MAC CE is a first BSR MAC CE, and the method further comprises: detecting a second condition of the buffer that corresponds to a second buffer condition of the plurality of buffer conditions; identifying, based on the configuration information, a second BSR format of the one or more BSR formats that is associated with the second buffer condition; generating a second BSR MAC CE with the second BSR format; and transmitting the second BSR MAC CE to the base station with the first BSR MAC CE.

Example 11 includes the method of example 1 or some other example herein, wherein the BSR format is a first BSR format, the BSR MAC CE is a first BSR MAC CE, and the method further comprises: selecting, based on the mapping, a second BSR format of the one or more BSR formats that is associated with the buffer condition; generating a second BSR MAC CE with the second BSR format, and transmitting the second BSR MAC CE to the base station with the first BSR MAC CE.

Example 12 includes the method of example 1 or some other example herein, wherein generating the BSR MAC CE comprises: identifying an information type value based on the condition of the buffer; and including the information type value within a type field of the BSR MAC CE to indicate a type of information included in the BSR MAC CE.

Example 13 includes a method of example 12 or some other example herein, wherein the type of information comprises: queuing information associated with the buffer, delay information associated with the buffer, or a characteristic of a protocol data unit (PDU) set in the buffer.

Example 14 includes a method of operating a user equipment (UE), the method comprising: determining a mapping of a plurality of buffer conditions to one or more buffer status report (BSR) tables; detecting a condition of a buffer of the UE that corresponds to a first buffer condition of the plurality of buffer conditions; selecting, based on the mapping, a BSR table of the one or more BSR tables that is associated with the first buffer condition; generating a BSR media access control (MAC) control element (CE) with an index selected from the BSR table; and transmitting the BSR MAC CE to a base station.

Example 15 includes the method of example 14 or some other example herein, wherein the first buffer condition is based on a determination of whether all protocol data units (PDUs) in a buffered PDU set are required by an application.

Example 16 includes a method of example 14 or some other example herein, wherein the first buffer condition is based on a comparison of a remaining time until a delivery deadline of buffered data to a predetermined threshold.

Example 17 includes a method of example 14 or some other example herein, wherein the first buffer condition is based on a comparison of the queuing time of buffered data to a predetermined threshold.

Example 18 includes the method of example 14 or some other example herein, wherein the first buffer condition is based on a comparison of an amount of buffered data to a predetermined threshold.

Example 19 includes the method of example 14 or some other example herein, wherein the first buffer condition is based on an importance or priority associated with a buffered protocol data unit (PDU) set.

Example 20 includes the method of example 14 or some other example herein, wherein the first buffer condition is based on whether packet discarding is configured for a buffered PDU set.

Example 21 includes a method of any one of examples 14-20 or some other example herein, wherein the buffer includes traffic for one or more logical channels (LCHs) of one or more logical channel groups (LCGs) and the buffer condition is associated with one or more LCHs of the plurality of LCHs or is associated with any of the plurality of LCHs.

Example 22 includes the method of example 14 or some other example herein, wherein the condition is a first condition, the BSR table is a first BSR table, the BSR MAC CE is a first BSR MAC CE, the index is a first index, and the method further comprises: detecting a second condition of the buffer that corresponds to a second buffer condition of the plurality of buffer conditions; identify, based on the configuration information, a second BSR table of the one or more BSR tables that is associated with the second buffer condition; generate a second BSR MAC CE with a second index selected from the second BSR table; and transmit the second BSR MAC CE to the base station with the first BSR MAC CE.

Example 23 includes a method of operating a user equipment (UE), the method comprising: receiving configuration information from a base station, the configuration information to map a plurality of buffer conditions to one or more buffer status report (BSR) timer configurations; detecting a condition of a buffer of the UE that corresponds to a first buffer condition of the plurality of buffer conditions; identifying, based on the configuration information, a BSR timer configuration of the plurality of BSR timer configurations that is associated with the first buffer condition; setting a timer based on the BSR timer configuration.

Example 24 includes a method of example 23 or some other example herein, wherein the first buffer condition is based on a determination of whether all protocol data units (PDUs) in a buffered PDU set are required by an application.

Example 25 includes the method of example 23 or some other example herein, wherein the first buffer condition is based on a comparison of a remaining time until a delivery deadline of buffered data to a predetermined threshold.

Example 26 includes the method of example 23 or some other example herein, wherein the first buffer condition is based on a comparison of the queuing time of buffered data to a predetermined threshold.

Example 27 includes the method of example 23 or some other example herein, wherein the first buffer condition is based on a comparison of an amount of buffered data to a predetermined threshold.

Example 28 includes the method of example 23 or some other example herein, wherein the first buffer condition is based on an importance or priority associated with a buffered protocol data unit (PDU) set.

Example 29 includes the method of example 23 or some other example herein, wherein the first buffer condition is based on whether packet discarding is configured for a buffered PDU set or a radio bearer corresponding to the buffered PDU set.

Example 30 includes a method of any one of examples 23-29 or some other example herein, wherein the buffer includes traffic for a plurality of logical channels (LCHs) of one or more logical channel groups (LCGs) and the first buffer condition is associated with one LCH of the plurality of LCHs or is associated with any of the plurality of LCHs.

Example 31 includes a method of example 23 or some other example herein, wherein the timer is a periodic BSR timer, a retransmit BSR timer, or a logical channel scheduling request delay timer.

Example 32 includes a method comprising: generating configuration information to map a plurality of buffer conditions to one or more buffer status report (BSR) formats, BSR tables, or BSR timer configurations; and transmitting the configuration information to a user equipment.

Example 33 includes the method of example 32 or some other example herein, further comprising: generating the configuration information based on characteristics associated with uplink traffic from the UE.

Example 34 includes a method of operating a user equipment (UE), the method comprising: detecting an event associated with a buffer; determining a delay timer associated with a buffer status report (BSR) type is running; determining the event is a predetermined triggering event; and triggering a BSR of the BSR type or a scheduling request (SR) for the BSR prior to a natural expiration of the delay timer based on determining the event is the predetermined triggering event.

Example 35 includes the method of example 34 or some other example herein, further comprising: considering the delay timer to be expired prior to the natural expiration based on determining the event is the predetermined triggering event; and triggering the BSR or the SR for the BSR based on determining the delay timer is expired.

Example 36 includes the method of example 35 or some other example herein, further comprising: stopping the delay timer prior to the natural expiration based on determining the event is the predetermined triggering event, wherein said determining the delay timer is expired is based on said stopping the delay timer.

Example 37 includes the method of example 34 or some other example herein, wherein the method comprises triggering the BSR prior to the natural expiration of the delay timer and: the delay timer is a retransmission BSR timer and the BSR type is a regular BSR type; or the delay timer is a periodic BSR timer and the BSR type is a periodic BSR type.

Example 38 includes the method of example 34 or some other example herein, wherein the method comprises triggering the SR for the BSR prior to the natural expiration of the delay timer, the delay timer is a logical channel SR delay timer, and the BSR type is a regular BSR type.

Example 39 includes the method of example 34 or some other example herein, wherein the BSR corresponds to a logical channel and the predetermined triggering event comprises a packet that is associated with the logical channel being discarded from the buffer.

Example 40 includes the method of example 34 or some other example herein, wherein the BSR corresponds to a logical channel and the predetermined triggering event comprises a queuing delay time for data associated with the logical channel in the buffer exceeding a predetermined threshold.

Example 41 includes the method of example 34 or some other example herein, wherein the BSR corresponds to a logical channel and the predetermined triggering event comprises a remaining time until a delivery deadline for data associated with the logical channel in the buffer being less than a predetermined threshold.

Example 42 includes the method of example 34 or some other example herein, wherein the predetermined triggering event comprises an amount of data in the buffer exceeding a predetermined threshold.

Example 43 includes the method of example 34 or some other example herein, wherein the BSR corresponds to a logical channel and the predetermined triggering event comprises a first protocol data unit (PDU) set arriving in the buffer with a first priority or importance level that is greater than any priority or importance level of a PDU set associated with the logical channel in the buffer at a time at which the first PDU set arrives in the buffer.

Example 44 includes a method of example 34 or some other example herein, wherein the predetermined triggering event comprises a number of protocol data units (PDU) of a PDU set in the buffer exceeding a predetermined threshold.

Example 45 includes the method of example 34 or some other example herein, wherein the predetermined triggering event comprises a data burst arriving in the buffer with a size that exceeds a predetermined threshold.

Example 46 includes a method of operating a user equipment (UE), the method comprising: detecting a triggering event associated with a buffer; triggering, based on detecting the triggering event, a buffer status report (BSR) of a BSR type that has precedence over a regular BSR type, a periodic BSR type, and a padding BSR type; and transmitting the BSR.

Example 47 includes the method of example 46 or some other example herein, wherein the BSR type is not associated with a retransmission BSR timer, a periodic BSR timer, or a logical channel scheduling request delay timer.

Example 48 includes the method of example 46 or some other example herein, wherein the BSR corresponds to a logical channel and detecting the triggering event comprises: determining a packet that is associated with the logical channel was discarded from the buffer.

Example 49 includes the method of example 46 or some other example herein, wherein the BSR corresponds to a logical channel and detecting the triggering event comprises: determining a queuing delay time for data associated with the logical channel in the buffer exceeds a predetermined threshold.

Example 50 includes the method of example 46 or some other example herein, wherein the BSR corresponds to a logical channel and detecting the triggering event comprises: determining a remaining time until a delivery deadline for data associated with the logical channel in the buffer is less than a predetermined threshold.

Example 51 includes the method of example 46 or some other example herein, wherein detecting the triggering event comprises: determining an amount of data in the buffer exceeds a predetermined threshold.

Example 52 includes the method of example 46 or some other example herein, wherein the BSR corresponds to a logical channel and detecting the triggering event comprises: determining a first protocol data unit (PDU) set with a first priority or importance level arrives in the buffer; and determining the first priority or importance level is greater than any priority or importance level of a PDU set associated with the logical channel in the buffer at a time at which the first PDU set arrives in the buffer.

Example 53 includes the method of example 46 or some other example herein, wherein detecting the triggering event comprises: determining a number of protocol data units (PDU) of a PDU set in the buffer exceeds a predetermined threshold.

Example 54 includes the method of example 46 or some other example herein, wherein detecting the triggering event comprises: determining a data burst arrives in the buffer with a size that exceeds a predetermined threshold.

Example 55 includes a method of operating a user equipment (UE), the method comprising: triggering a buffer status report associated with a buffer; discarding a packet of the uplink data from the buffer after triggering the buffer status report; and canceling the buffer status report based on discarding the packet from the buffer.

Example 56 includes the method of example 51 or some other example herein, further comprising: stopping a delay timer associated with the buffer status report based on cancelling the buffer status report.

Example 57 includes the method of example 51 or some other example herein, further comprising: discarding one or more packets of the uplink data from the buffer, the one or more packets to include the packet; determining an aggregated size of the one or more packets is greater than a predetermined threshold size; and canceling the buffer status report based on determining the aggregated size is greater than the predetermined threshold size.

Another example may include one or more non-transitory computer-readable media comprising instructions to cause an electronic device, upon execution of the instructions by one or more processors of the electronic device, to perform one or more elements of a method described in or related to any of examples 1-57 , or any other method or process described herein.

Another example may include an apparatus comprising logic, modules, or circuitry to perform one or more elements of a method described in or related to any of examples 1-57 , or any other method or process described herein.

Another example may include a method, technique, or process as described in or related to any of examples 1-57 , or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-57 , or portions thereof.

Another example include a signal as described in or related to any of examples 1-57 , or portions or parts thereof.

Another example may include a datagram, information element, packet, frame, segment, PDU, or message as described in or related to any of examples 1-57 , or portions or parts thereof, or otherwise described in the present disclosure.

Another example may include a signal encoded with data as described in or related to any of examples 1-57 , or portions or parts thereof, or otherwise described in the present disclosure.

Another example may include a signal encoded with a datagram, IE, packet, frame, segment, PDU, or message as described in or related to any of examples 1-57 , or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-57 , or portions thereof.

Another example may include a computer program comprising instructions, wherein execution of the program by a processing element is to cause the processing element to carry out the method, techniques, or process as described in or related to any of examples 1-57 , or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

1.-34. (canceled)

35. A method for wireless communication, the method comprising:
determining a mapping of a plurality of buffer conditions to one or more buffer status report (BSR) formats;
detecting a condition of a buffer that corresponds to a first buffer condition of the plurality of buffer conditions;
selecting, based on the mapping, a BSR format of the one or more BSR formats that is associated with the first buffer condition; and
generating, for transmission to a base station, a BSR media access control (MAC) control element (CE) with the BSR format.

36. The method of claim 35, further comprising:
receiving configuration information from the base station; and
determining the mapping based on the configuration information.

37. The method of claim 35, wherein the first buffer condition is based on a comparison of an amount of buffered data to a predetermined threshold.

38. The method of claim 35, wherein the first buffer condition is based on a determination of whether all protocol data units (PDUs) in a buffered PDU set are required by an application.

39. The method of claim 35, wherein the first buffer condition is based on a comparison of a remaining time until a delivery deadline of buffered data to a predetermined threshold

40. The method of claim 35, wherein the first buffer condition is based on a comparison of a queuing time of buffered data to a predetermined threshold.

41. The method of claim 35, wherein the buffer includes traffic for a plurality of logical channels (LCHs) of one or more logical channel groups (LCGs) and the first buffer condition is associated with one or more LCHs of the plurality of LCHs or is associated with any of the plurality of LCHs.

42. The method of claim 35, wherein the condition is a first condition, the BSR format is a first BSR format, the BSR MAC CE is a first BSR MAC CE, and the method further comprises:
detecting a second condition of the buffer that corresponds to a second buffer condition of the plurality of buffer conditions;
identifying, based on configuration information from the base station, a second BSR format of the one or more BSR formats that is associated with the second buffer condition; and
generating, for transmission to the base station, a second BSR MAC CE with the second BSR format.

43. The method of claim 35, wherein the BSR format is a first BSR format, the BSR MAC CE is a first BSR MAC CE, and the method further comprises:
selecting, based on the mapping, a second BSR format of the one or more BSR formats that is associated with the first buffer condition; and
generating, for transmission to the base station with the first BSR MAC CE, a second BSR MAC CE with the second BSR format.

44. The method of claim 35, wherein generating the BSR MAC CE comprises:
including a type value within a type field of the BSR MAC CE to indicate a BSR table upon which the BSR MAC CE is based.

45. One or more non-transitory, computer-readable media having instructions that, when executed, cause processing circuitry to:
determine a mapping of a plurality of buffer conditions to one or more buffer status report (BSR) tables;
detect a condition of a buffer that corresponds to a first buffer condition of the plurality of buffer conditions;
select, based on the mapping, a BSR table of the one or more BSR tables that is associated with the first buffer condition; and
generate, for transmission to a base station, a BSR media access control (MAC) control element (CE) with an index selected from the BSR table.

46. The one or more non-transitory, computer-readable media of claim 45, wherein the first buffer condition is based on a comparison of an amount of buffered data to a predetermined threshold.

47. The one or more non-transitory, computer-readable media of claim 45, wherein the first buffer condition is based on: a determination of whether all protocol data units (PDUs) in a buffered PDU set are required by an application; a comparison of a remaining time until a delivery deadline of buffered data to a predetermined threshold; a comparison of a queuing time of buffered data to a predetermined threshold; or an importance or priority associated with a buffered protocol data unit (PDU) set; or whether packet discarding is configured for a buffered PDU set.

48. The one or more non-transitory, computer-readable media of claim 45, wherein the buffer includes traffic for a plurality of logical channels (LCHs) of one or more logical channel groups (LCGs) and the first buffer condition is associated with one or more LCHs of the plurality of LCHs or is associated with any of the plurality of LCHs.

49. The one or more non-transitory, computer-readable media of claim 45, wherein the condition is a first condition, the BSR table is a first BSR table, the BSR MAC CE is a first BSR MAC CE, the index is a first index, and the instructions, when executed, further cause the processing circuitry to:
detect a second condition of the buffer that corresponds to a second buffer condition of the plurality of buffer conditions;
identify, based on configuration information from the base station, a second BSR table of the one or more BSR tables that is associated with the second buffer condition;
generate a second BSR MAC CE with a second index selected from the second BSR table; and
transmit the second BSR MAC CE to the base station with the first BSR MAC CE

50. The one or more non-transitory, computer-readable media of claim 45, wherein to generate the BSR MAC CE the processing circuitry is to:
include a type value within a type field of the BSR MAC CE to indicate the BSR table upon which the BSR MAC CE is based.

51. A method comprising:
generating configuration information to map a plurality of buffer conditions to one or more buffer status report (BSR) formats or BSR tables; and
generating, for transmission to a user equipment (UE), a message that includes the configuration information.

52. The method of claim 51, further comprising:
generating the configuration information based on characteristics associated with uplink traffic from the UE.

53. The method of claim 51, further comprising:
processing a BSR media access control (MAC) control element (CE) received from the UE, the BSR MAC CE having a BSR format based on the configuration information.

54. The method of claim 53, wherein the BSR MAC CE includes a type value within a type field to indicate a BSR table upon which the BSR MAC CE is based.
